(19) United States
(12) Patent Application Publication
(10) Pub. No.: US 2009/0235946 A1
(43) Pub. Date: Sep. 24, 2009

(54) Cosmetic color-selection tool

(76) Inventors: Karen Kay Kalla, Cincinnati, OH (US); Laura Elaine Bush, Ellicott City, MD (US); Patricia Alison LaFleur, Shewsbury, PA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/082,566

(22) Filed: Apr. 11, 2008

Related U.S. Application Data
(60) Provisional application No. 60/923,157, filed on Apr. 12, 2007.

(51) Int. Cl. A45D 40/00; G09B 19/00

(52) U.S. Cl. 132/200; 434/100

(57) ABSTRACT

A cosmetic color-selection tool comprises at least one monochromatic black area and a plurality of discrete sample regions, each sample region comprising a single cosmetic color having a perimeter thereof, wherein at least a portion of the perimeter of each of the sample regions abuts the monochromatic black area.

### CROSS REFERENCE TO RELATED APPLICATION

This application claims the benefit of U.S. Provisional Application No. 60/923,157 filed Apr. 12, 2007.

### FIELD OF THE INVENTION

The present invention relates to color cosmetics, and more particularly to tools and devices that can be used in color-cosmetic applications for selecting a correct color of the color-cosmetic product, including skin-care products, nails products, hair products, eye products, and lips products.

### BACKGROUND OF THE INVENTION

Cosmetic devices designed to allow a consumer to select the correct color to match one's skin color are known. For example, U.S. Pat. No. 5,178,169 is directed to a cosmetic-selecting device comprising a flexible strip having major face divided longitudinally into a series of comparison zones, each zone being marked in at least one of the different color, color and tone of cosmetic product from an adjacent zone and corresponding cosmetic identifying indicia, opposite ends of the strip having respective finger-pieces such that the strip can be manually flexed against the skin to bring a plurality of adjacent zones into juxtaposition therewith for precise comparison purposes. Another example of such cosmetic devices is described in Japanese patent publication 2001-112538, directed to a skin color sample tool in which colors are printed on the surfaces of colorless transparent see-through strips.

Our research indicates that many women experience difficulty in choosing the right color of cosmetics. More specifically, we discovered that in many instances women tend to select a color not exactly matching the color of their skin, even when such matching colors are readily available. We believe that a key reason for this phenomenon is the tendency of many consumers to perceive their skin to be lighter than it really is. The diagram of FIG. 9 shows the results of a study conducted with 202 Caucasian-skin females aged 18-65. Each panelist was presented with several cosmetic color samples, typically associated with the Caucasian-type skin (from Color 01 to Color 06 in the diagram), successively and uniformly disposed on a white background from the lightest color to the darkest color. Each panelist was asked to choose the color most closely matching her natural skin. As the diagram of FIG. 9 demonstrates, the panelists consistently chose samples having lighter colors (i.e., the colors having a higher “L” value) than the natural color of their skin. Obviously, a tool that would shift the consumer's selection toward more accurate, darker colors can facilitate a more satisfying consumer's experience with respect to matching the color of cosmetic products to that of the consumer's natural skin.

Without wishing to be limited by any theory, we further believe that one of the main factors influencing human perception of colors, particularly when the colors are presented as series of discrete, relatively small samples, lies in the choice of the color surrounding the samples.

The present invention is directed, therefore, to a novel cosmetic color-selection tool structured such that the samples of cosmetic colors can be viewed relative to the background that facilitates a more accurate consumer's perception of the cosmetic-colors samples presented relative to the consumer's own skin color. The present invention is further directed to a process for assisting a consumer with selecting a correct cosmetic color, including a step of providing the consumer with the novel cosmetic color-selection tool of the present invention.

### SUMMARY OF THE INVENTION

A cosmetic color-selection tool of the present invention comprises at least one monochromatic black area and a plurality of discrete sample regions. Each sample region comprises a single cosmetic color having a perimeter thereof. At least a portion of the perimeter of each of the sample regions abuts the monochromatic black area.

The portion of the sample perimeter abutting the monochromatic black area can be at least 20%, at least 40%, at least 60% of the entire perimeter of the sample region, or the sample regions can be completely encompassed by the monochromatic black area.

The color-selection tool may be embodied in a variety of ways. Some non-limiting examples include: a single strip of material or a plurality of strips of material, a product label permanently or removably attached to the product, an image on a computer screen, including iPod® screen, a cellular-phone (such as Blackberry® for example) screen, and a screen of any other similar electronic device. The color-selection tool may also be a part of a printed instruction, flyer, or any other advertising material.

The color-selection tool may comprise a single physical component, for example a plastic sheet, or may comprise multiple components, for example a plurality of paper or plastic strips, or a combination of a background sheet and a transparent sheet (or sheets) having a plurality of sample regions (or a single sample region) thereon, so that the transparent sheet with the sample region or regions thereon can be superimposed with the background sheet. In the latter embodiment, the two sheets may be interconnected, either integrally or superficially, or may comprise two separate sheets not physically connected to one another. The cosmetic color-selection tool may comprise a flexible strip or sheet of material, designed to at least partially conform to contours of a portion of a human face or body. If desired, the color-selection tool may include a mirror therein. In one embodiment, a portion of the tool comprises a transparent area, and the cosmetic samples are superimposed with both the black monochromatic area and the transparent area of the tool.

The discrete sample regions may have identical surface areas and shapes, or may differ in at least one of their respective areas and shapes. Typically, but not necessarily, the discrete sample regions are disposed in a non-random pattern, and consecutively from the lightest-color sample to the darkest-color sample.

The discrete sample regions may be structured to comprise real cosmetic product secured on the surface of the tool by any means known to those skilled in the art. Alternatively or additionally, the sample regions may be printed on the surface of the tool by any means known to those skilled in the art. The embodiment is contemplated wherein at least some of the sample regions are both printed and include the real cosmetic product.

In another embodiment, the discrete sample regions may have color-identifying indicia printed or otherwise disposed therein. Alternatively, the color-identifying indicia may be disposed in the proximity to the sample regions. The color-identifying indicia can be presented in a monochromatic black, or any other suitable color.

A process of the present invention, for assisting a consumer with selecting a correct cosmetic color, comprises a step of providing the consumer with a cosmetic color-selection tool comprising at least one monochromatic black area and a plurality of discrete sample regions, each sample region comprising a single cosmetic color having a perimeter thereof, wherein at least a portion of the perimeter of each of the sample regions abuts the monochromatic black area. The process may further include a step of directing the consumer to compare the plurality of discrete of discrete sample regions of the cosmetic color-selection tool with a target area of the consumer. The target area can be selected from the group consisting of skin, hair, nails, eyes, and lips of the consumer.

### BRIEF DESCRIPTION OF THE DRAWINGS

FIG. 1 is a schematic plan view of an embodiment of the color-selection tool of the present invention.

FIG. 2 is a schematic plan view of another embodiment of the color-selection tool of the present invention.

FIG. 3 is a schematic plan view of yet another embodiment of the color-selection tool of the present invention.

FIG. 4 is a schematic plan view of an embodiment of the color-selection tool of the present invention, exemplarily shown as disposed on a cosmetic product.

FIG. 5. is a schematic plan view of another embodiment of the color-selection tool of the present invention, exemplarily shown as disposed on a cosmetic product.

FIG. 6 is a schematic plan view of an embodiment of the color-selection tool of the present invention, comprising a plurality of strips.

FIG. 7 is a schematic perspective view of an embodiment of the color-selection tool of the present invention, comprising a combination of a background sheet and a transparent sheet having a plurality of sample regions thereon, the transparent sheet being superimposed with the background sheet.

FIG. 8 is a schematic perspective view of an embodiment of the color-selection tool of the present invention, wherein the color-selection tool is presented on the computer screen.

FIG. 9 is a diagram showing the results of a color-selection study conducted without the use of the color-selection tool of the present invention.

FIG. 10 shows two test palettes, one having a white background and the other comprising an embodiment of the color-selection tool of the present invention having a black background, each palette having a plurality of cosmetic color samples thereon, and a diagram showing the results of a color-selection study using the two palettes.

FIG. 11 is identical to FIG. 10, except that the two palettes shown in black-and-white in FIG. 10 are shown in color in FIG. 11.

### DETAILED DESCRIPTION OF THE INVENTION

All references to colors herein assume visually perceived colors, and are based on either the Hunter L, a, b Color Scale, or the CIE L*, a*, b* Color Scale, both of which should be known to one skilled in the art, see “The Basics Of Color Perception and Measurement” published by HunterLab in 2001, Version 1.4 (can be found on the Net at http://www.hunterlab.com/colorbasics_shows.php), incorporated herein by reference.

As used herein, the following terms have the following meaning:

“Luminance value” (“L”) is defined on the scale from “pure black” having the luminance value of “0” to “pure white” having the luminance value of “100.”

“Chroma value” (“C”) is the vector distance from the center of the color space to the measured color; it is intended to designate saturation or intensity of a color and distinguishes color intensity from clarity (i.e. vividness vs. dullness). The lower the chroma of the color, i.e. the less its intensity, the closer the color is to being a so-called “neutral” color. Chroma values for pure colors (red, green, blue) are over 100, whereas chroma values for grey colors are near zero.

“Black” means a color having a luminance value of less than about 40 and a chroma value of less than about 60, more specifically L of less than about 30 and C of less than about 30, even more specifically L of less than about 20 and C of less than about 30, and still more specifically L of less than about 20 and C of less than about 15, wherein the illuminant is D65 with a 10-degree observer.

“Cosmetic color” is a color that can comprise a pigment or a dye and that can be used in cosmetic products.

“Light” color and “dark” color, or “the lightest” color and “the darkest” color (and any permutations thereof) are relative terms meant to indicate that in the present context of color cosmetics, one (“light” or “lighter”) color is perceived by an ordinary observer as lighter than the other (“dark” or “darker”) color. Typically, but not necessarily, a “light” or “lighter” color may have the luminance value that is greater than that of the “dark” or “darker” color. Other color characteristics, such as, for example, chroma value and/or hue, may affect the consumers' perception as to what can be considered a “light” or “lighter” color relative to a “dark” or “darker” color.

“Monochromatic” color means a single color that appears to the human eye to be uniformly distributed throughout a reference area.

“Target area” is a portion of a consumer's body, including, without limitation, skin, hair, lips, nails, eyes, and teeth, to which portion sample areas of the color-selection tool of the present invention can be compared for the purpose of choosing the correct cosmetic color.

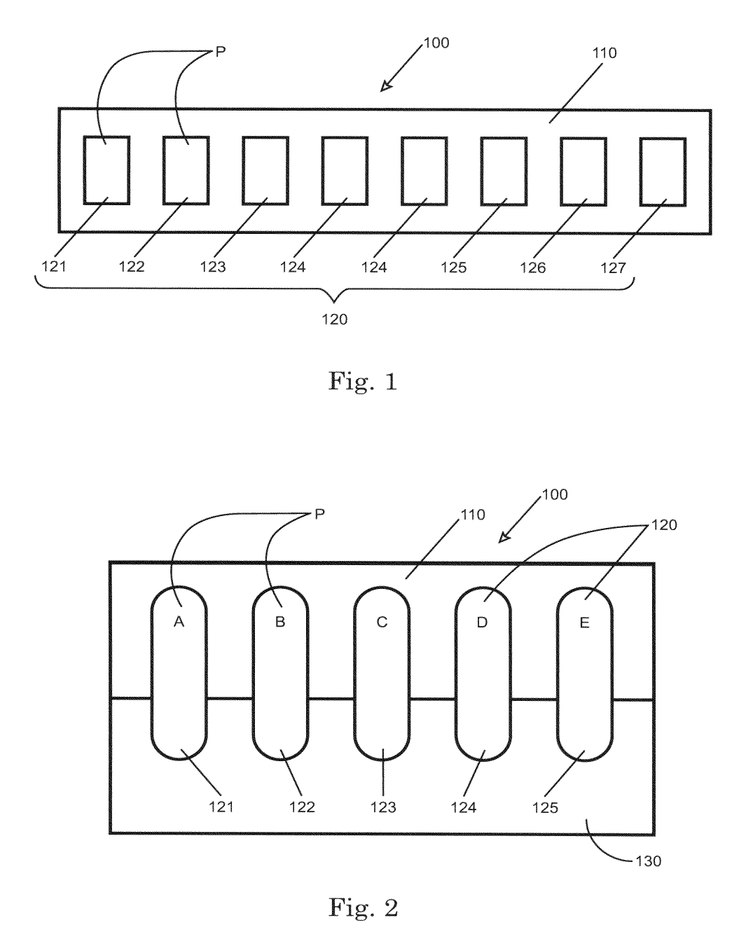

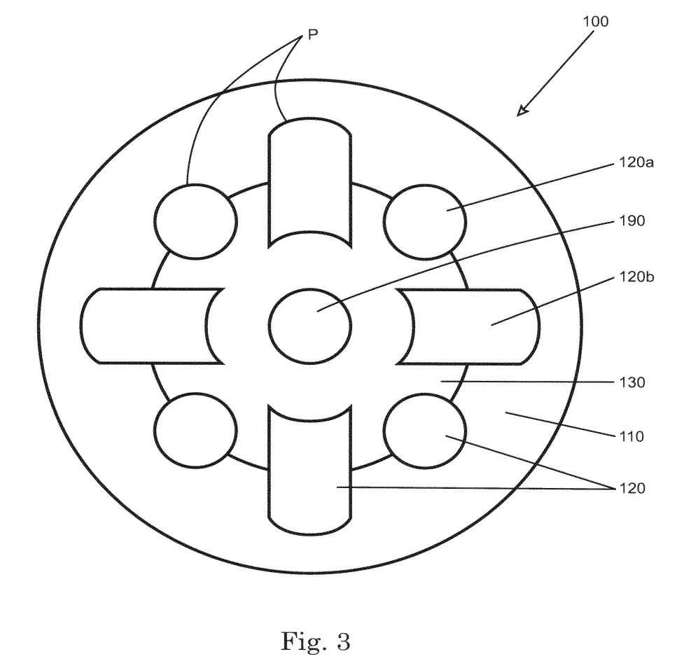

A cosmetic color-selection tool, or simply “tool,” 100 of the present invention comprises at least one monochromatic black area 110 and a plurality of discrete sample regions 120, FIGS. 1 and 2. Each sample region 120 comprising a single cosmetic color (designated, for example, as 121, 122, 123, 124, 125, 126, 127 in FIG. 1) has a perimeter “P” thereof. According to the present invention, at least a portion of the perimeter P of each of the sample regions 120 abuts the monochromatic black area 110. The portion of the sample region's perimeter P abutting the monochromatic black area 110 can be at least 20% of the entire perimeter P of that sample region 120. In another embodiment, such portion of the perimeter P can be at least 40% thereof, FIG. 3. In still another embodiment, such portion of the perimeter P can be at least 60% of the entire perimeter of the sample region 120, FIG. 2. Finally, 100% of the perimeter P of the sample region 120 can abut the monochromatic black area 110, FIG. 1. In the latter instance, the discrete sample region 120 is completely encompassed by the monochromatic black area 110.

FIGS. 2 and 3 show embodiments of the color-selection tool 100, in which a portion of the tool 100 comprises a transparent area 130. In such an embodiment the sample regions 120 can be disposed so that the perimeters P of the individual sample regions 120 abut both the black monochromatic area 110 and the transparent area 130. Put another way, the sample regions 120 can be superimposed with both the black monochromatic area 110 and the transparent area 130 of the tool 100.

The sample regions 120 may have any suitable shapes and surface areas: for example, rectangular (FIG. 1), triangular (not shown), oval (FIG. 2), circular (FIG. 3), the combination thereof (FIG. 3), and even have geometrically irregular shape (not shown). The sample regions 120 may have identical surface areas and shapes or may differ in at least one of their respective areas and shapes. For example, each of FIGS. 1 and 2 shows an embodiment of the color-selection tool 100 comprising the sample areas 120 having identical surface areas. Aside from the convenience of uniformity and aesthetic considerations, it is believed that the consumer's choice of colors will not be influenced by the shapes of the sample regions 120 if those shapes are identical. Alternatively, FIG. 3 shows an embodiment of the tool 100 comprising the sample areas 120 having differential shapes 120a, 120b.

It may be beneficial (while not necessary) to structure the tool 100 such that the sample regions 120 are disposed in a non-random pattern, as shown in FIGS. 1-8. It may be also beneficial to dispose the sample regions 120 consecutively from the lightest-color sample region to the darkest-color sample region. It is believed that such an arrangement facilitates the consumer's correct choice of color. The pattern of the plurality of sample regions 120 can be arranged in either an aesthetically pleasing continuum or a technically defined continuum or a combination of both.

One skilled in the art will appreciate that the sample regions 120 may comprise either real cosmetic product secured in the tool or/and a color representation. In the former instance, the cosmetic product can be secured by any means known in the art. For example, a sample of a cosmetic material can be encapsulated within a transparent material, such, for example, as a thermoplastic material, as taught by U.S. Pat. No. 5,150,791, issued on Sep. 29, 1992 in the names of Kamen, et al., the disclosure of which is incorporated herein by reference.

Alternatively or additionally, the sample regions 120 may be printed on the tool's surface by any means known in the art. The embodiment is also contemplated in which the sample region 120 can be formed by both a printed representation and the real cosmetic product. For example, a cosmetic product may be deposited and secured upon a pre-printed region. Finally, some of the sample regions 120 can be printed while others can comprise the cosmetic product.

The color-selection tool 100 of the present invention may include color-identifying indicia with respect to the individual sample regions 120, which indicia can comprise color's name, symbol, or any other designation, and can be printed or otherwise disposed therein to identify a specific color of the sample region 120, as schematically shown in FIG. 2 (indicia A, B, C, D, and E) and FIG. 6 (indicia A). Alternatively, the color-identifying indicia may be disposed in the proximity of the sample regions 120 on either side of the tool (not shown). The color-identifying indicia can be presented in a monochromatic black, or any other suitable color.

While the use of the color-selection tool 100 of the present invention is believed to be particularly beneficial in choosing the color of skin-care cosmetic applications (face foundations, face/body creams, body lotions, sun lotions, etc.), the tool 100 can be used in choosing colors of a broad variety of cosmetic applications, such as, for example, hair care products (shampoos, conditioners, dyes, etc), lip-color products (lipsticks, lip gloss, lip balms, etc.), eyes products (eye colors, mascara, etc.), and nails (nail polish).

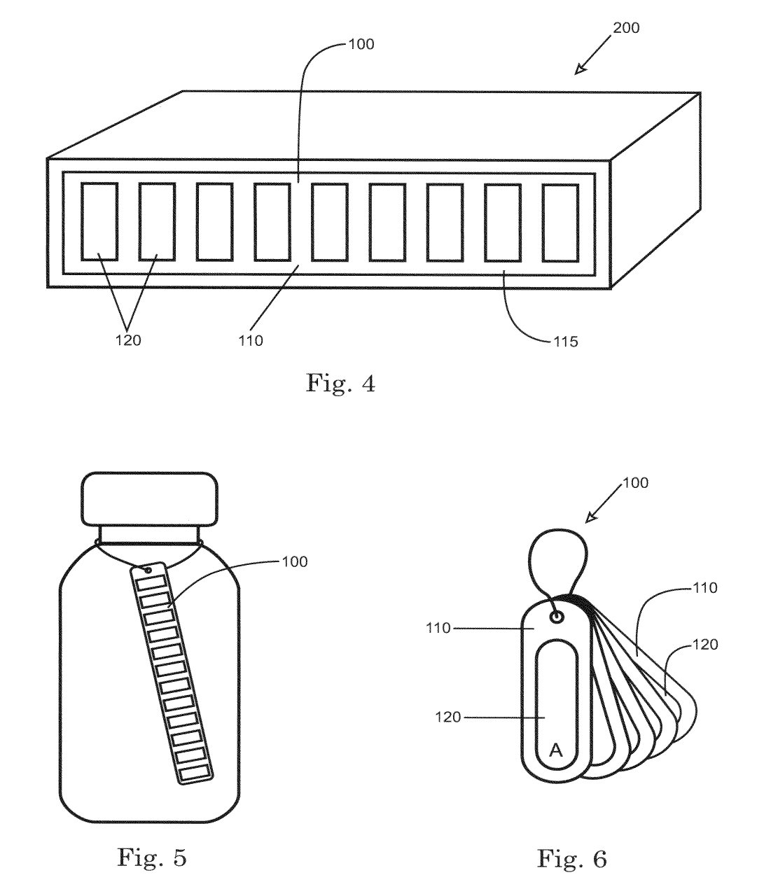

Depending on the field of application, the color-selection tool 100 of the present invention may have a variety of physical embodiments. For example, the tool 100 may comprise a single strip of material not physically associated with an otherwise packaged cosmetic product, as schematically shown in FIGS. 1 and 2. The tool 100 may also comprise a part of a printed instruction, flyer, or any other advertising material (not shown). The embodiment is contemplated, in which the cosmetic color-selection tool 100 comprises a flexible strip or sheet of material, designed to at least partially conform to contours of a target area. Other embodiments of the tool 100 of the present invention include a product label 115 (FIGS. 4 & 5) permanently or removably attached to the product, wherein the label has a black monochromatic background 110. If desired, the tool 100 may include a reflective surface therein, such as a mirror, to allow a consumer to see a target area (for example, a face) in conjunction with one or more sample regions 120.

The tool 100 of the present invention can comprise an image on a computer screen 350 of a computer 300, showing a cosmetic color samples 120 superimposed with the monochromatic black background 110 in accordance with the present invention, FIG. 8. Devices such as cellular phone having color screen, iPod®, BlackBerry®, and other similar devices having a suitable screen are all included in the scope of this invention.

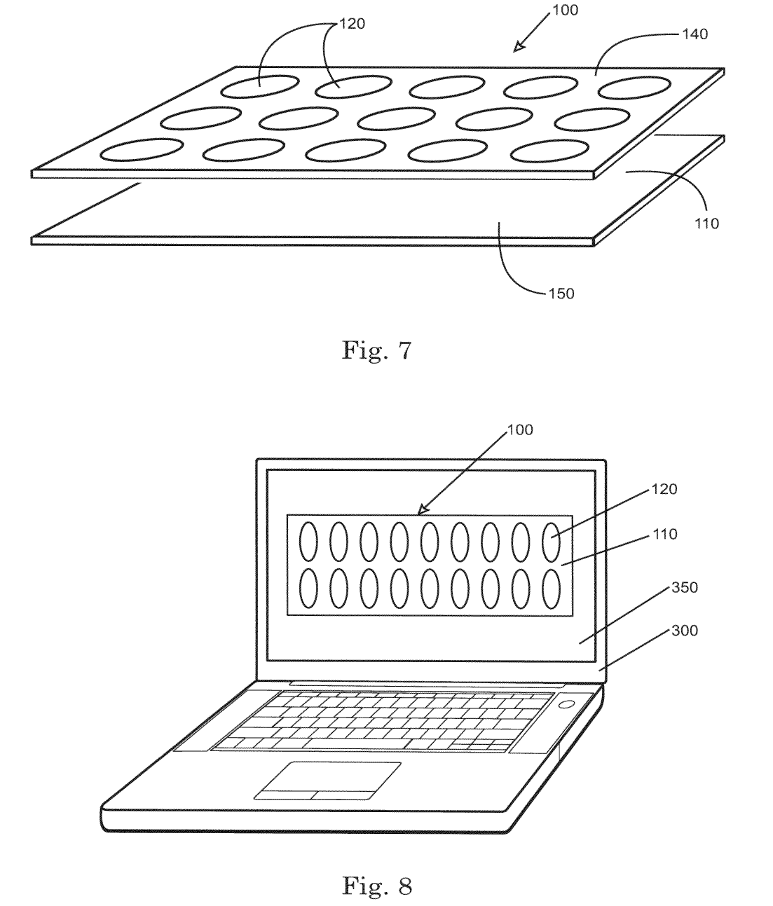

The tool 100 may comprise a single physical component, for example a plastic sheet, FIGS. 1 and 2. Alternatively, the tool 100 may comprise multiple components, for example a plurality of paper or plastic strips, loosely interconnected as shown in FIG. 6, to allow a user to select one or more sample regions 120 at a time and compare them to a target area. FIG. 7 shows another embodiment of the tool 100, comprising a combination of a black monochromatic background sheet 150 and a transparent sheet 140 having the sample regions 120 thereon, so that the transparent sheet 140 with the sample regions 120 thereon can be superimposed with the black-background sheet 150. The black-background sheet 150 and the transparent sheet 140 are shown in FIG. 7 as two separate sheets not physically connected to one another, but it should be understood that an embodiment is contemplated wherein the two sheets 140, 150 are interconnected, either integrally and/or permanently or superficially and/or temporarily. The latter embodiment is fully in the knowledge scope of those skilled in the art and therefore is not shown herein.

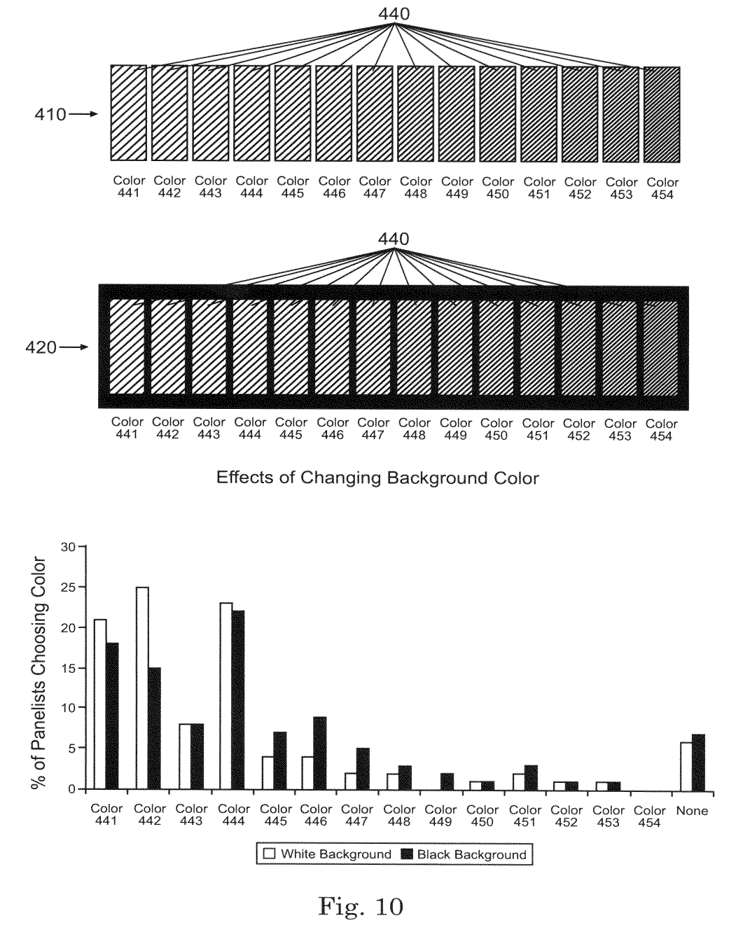

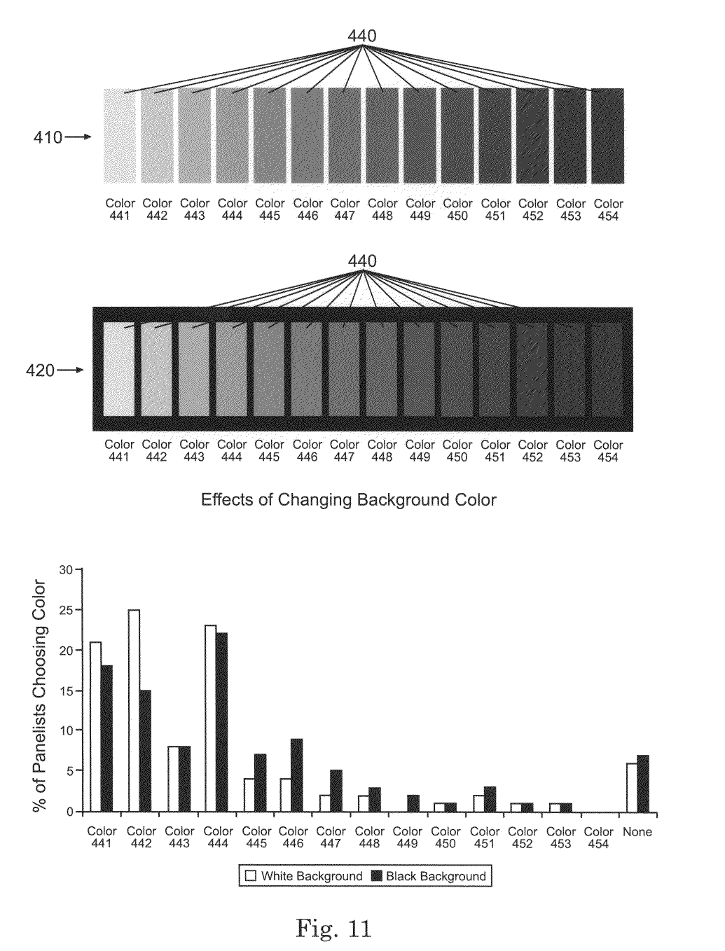

A diagram shown in FIG. 10 exemplifies the results of a study that was designed to compare human's perception of cosmetic colors based on the colors' background. In this study, the panelists were presented with two palettes 410, 420, each having identical fourteen cosmetic-color sample regions 440 (individual colors being designated successively from 441 to 454) disposed uniformly and consecutively from the lightest cosmetic color (extreme left in FIG. 10) to the darkest cosmetic color (extreme right in FIG. 10). The first palette 410 had a monochromatic white background, and the second palette 420 had a monochromatic black background. The range of colors 441-444 represented cosmetic colors typically associated with light, Caucasian-type skin, the color 441 being the lightest color and the color 444 being the darkest color in this range. The range of samples 447-454 represented cosmetic colors typically associated with dark, African-American-type skin, the color 447 being the lightest color and the color 454 being the darkest color in this range. The “intermediate” colors 445 and 446 could be attributed to either of the above groups, depending on a particular individual skin shade.

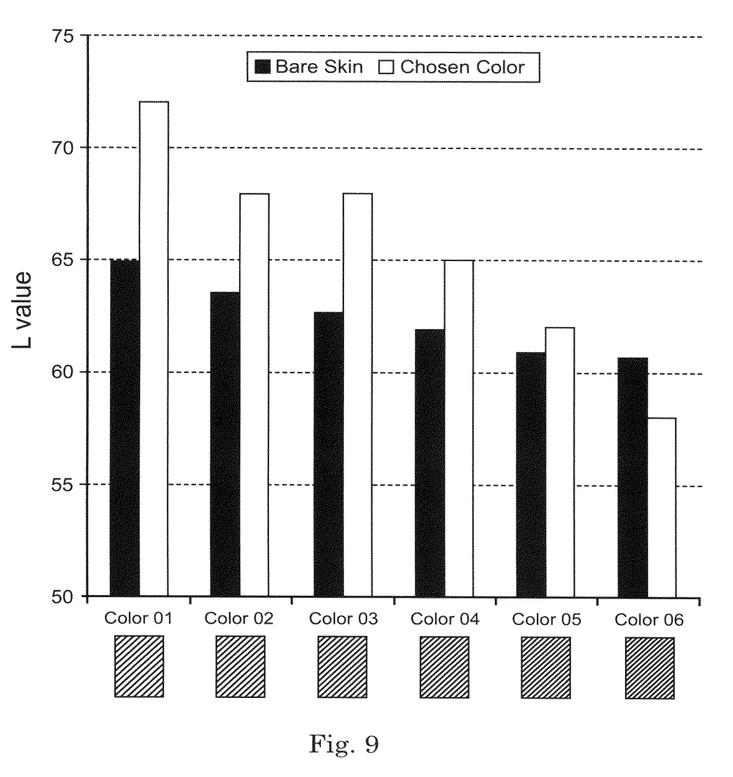

As the diagram “Effect of Changing Background Color” of FIG. 10 shows, with respect to the light colors 441-444, a larger proportion of Caucasian-type-skin panelists chose lighter samples from the white-background palette 410 than from the black-background palette 420. It confirmed our supposition that at least with respect to a light-color skin, an average consumer tends to prefer relatively lighter colors when presented with the range of cosmetic colors disposed on a white-background palette 410. This result correlates with the results of our previous study, discussed herein in the Background and reflected in the diagram of FIG. 9. This also shows that at least to the extent the Caucasian-type-skin consumers are concerned, the desired shift of the consumers' perception towards darker, and more correct, cosmetic colors occurs when the consumers are presented with the range of colors disposed on the black-background palette 420.

Hence, a process for assisting a consumer with selecting a correct cosmetic color can comprise a step of providing the consumer with a cosmetic color-selection tool 100 of the present invention, having a black monochromatic background 110 and a plurality of sample regions 120. Then the consumer can compare the plurality of sample regions 120 of the tool 100 with a target area and make a more accurate choice with respect to the cosmetic color. The target area can be selected from the group consisting of skin, hair, nails, eyes, and lips of the consumer. The tool 100 can be conveniently equipped with a mirror.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cosmetic color-selection tool comprising at least one monochromatic black area and a plurality of discrete sample regions, each sample region comprising a single cosmetic color having a perimeter thereof, wherein at least a portion of the perimeter of each of the sample regions abuts the monochromatic black area.

2. The cosmetic color-selection tool according to claim 1, wherein the portion of the perimeter abutting the monochromatic black area is at least 20% of the perimeter of each of the plurality of discrete sample regions.

3. The cosmetic color-selection tool according to claim 1, wherein the portion of the perimeter abutting the monochromatic black area is at least 40% of the perimeter of each of the plurality of discrete sample regions.

4. The cosmetic color-selection tool according to claim 1, wherein the portion of the perimeter abutting the monochromatic black area is at least 60% of the perimeter of each of the plurality of discrete sample regions.

5. The cosmetic color-selection tool according to claim 1, wherein each of the plurality of discrete sample regions is encompassed by the monochromatic black area.

6. The cosmetic color-selection tool according to claim 1, wherein the tool comprises a transparent portion.

7. The cosmetic color-selection tool according to claim 1, wherein the discrete sample regions have identical surface areas and shapes.

8. The cosmetic color-selection tool according to claim 1, wherein the discrete sample regions are disposed in a non-random pattern and successively from the lightest color to the darkest color.

9. The cosmetic color-selection tool according to claim 8, wherein at least some of the discrete sample regions comprise cosmetic product.

10. The cosmetic color-selection tool according to claim 8, wherein each of the discrete sample regions comprises identifying indicia.

11. A cosmetic color-selection tool comprising:
(a) a strip of material having a black monochromatic area thereon, the strip having a strip perimeter, and
(b) a plurality of discrete sample regions disposed on the strip in a non-random pattern, each sample region comprising a single cosmetic color having a sample perimeter thereof,
wherein at least a portion of the sample perimeter of each of the sample regions abuts the monochromatic black area, and wherein no portion of the sample perimeter of each of the sample regions coincides with the strip perimeter.

12. The cosmetic color-selection tool according to claim 11, wherein the portion of the sample perimeter abutting the monochromatic black area is at least 40% of the sample perimeter of each of the plurality of discrete sample regions.

13. The cosmetic color-selection tool according to claim 11, wherein each of the discrete sample regions is encompassed by the monochromatic black area.

14. The cosmetic color-selection tool according to claim 11, wherein the tool comprises a transparent portion.

15. The cosmetic color-selection tool according to claim 11, wherein the discrete sample regions have identical surface areas and shapes.

16. The cosmetic color-selection tool according to claim 11, wherein the discrete sample regions are disposed in a non-random pattern and successively from the lightest color to the darkest color.

17. The cosmetic color-selection tool according to claim 11, wherein the tool comprises a flexible strip designed to at least partially conform to contours of a portion of a human face or body.

18. A process for assisting a consumer with selecting a correct cosmetic color, the process comprising a step of providing the consumer with a cosmetic color-selection tool comprising at least one monochromatic black area and a plurality of discrete sample regions, each sample region comprising a single cosmetic color having a perimeter thereof, wherein at least a portion of the perimeter of each of the sample regions abuts the monochromatic black area.

19. The process according to claim 18, further comprising a step of directing the consumer to compare the plurality of discrete sample regions of the cosmetic color-selection tool with a target area, the target area being selected from the group consisting of skin, hair, nails, eyes, and lips of the consumer, and combinations thereof.

20. The process according to claim 18, wherein in the step of providing the consumer with a cosmetic color-selection tool, the cosmetic color-selection tool comprises a mirror.
